(19) United States
(12) Patent Application Publication
(10) Pub. No.: US 2009/0045753 A1
(43) Pub. Date: Feb. 19, 2009

(54) LED lamp string

(76) Inventor: Chin-Weih Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,529

(22) Filed: Aug. 14, 2007

(51) Int. Cl. H05B 37/00

(52) U.S. Cl. 315/192

(57) ABSTRACT

A LED lamp string, especially indicating a type of LED lamp string, which plug-fitting directly into AC power socket, and a controllable blinking or non-blinking structure which combining two or more than two groups of dual crystal current controllers in the main electrical wire circuitry to achieve results of bridge rectifier to make the current flowing through the LED lamp string become the state of DC current and thus achieve the non-blinking effect.

### BACKGROUND OF THE INVENTION

Owing to the current orientation feature of ordinary LED lamp strings, they can only produce the light emitting effect while specified direction of current is provided. Therefore, the known LED lamp strings need to use DC current as their power. LED lamp strings will become blinking owing to the current switching while they were combined with AC current. In order to have the LED lamp string use DC current as power directly and conveniently and also with no blinking phenomena, it is know to use a bridge typed rectifier (4) (normally called “bridge stacks”), which is connect-fit onto a main electrical power line located between a plug (2) and a LED lamp string (3), as shown in FIG. 1, to achieve the purpose of rectifying thus provide DC current continuously to have LED lamp strings provide no blinking light.

### SUMMARY OF THE INVENTION

The main object of this invention is to provide an improved control structure which is able to be assembled on the electrical wires of LED lamp strings to link several LCD lamp strings simultaneously and achieve the effects of all non-blinking, partial non-blinking or partial blinking by using the innovative design. The characteristics and structures of the present invention will be described hereafter by referring to drawings.

### BRIEF DESCRIPTION OF THE DRAWINGS

FIG. 1 is a plan view showing a known structure of the LED lamp string combined with the bridge typed rectifier.

FIG. 2 is a plan view showing a first embodiment according to the present invention.

FIG. 3 is a plan view showing a second embodiment according to the present invention.

FIG. 4 is a plan view showing a third embodiment according to the present invention.

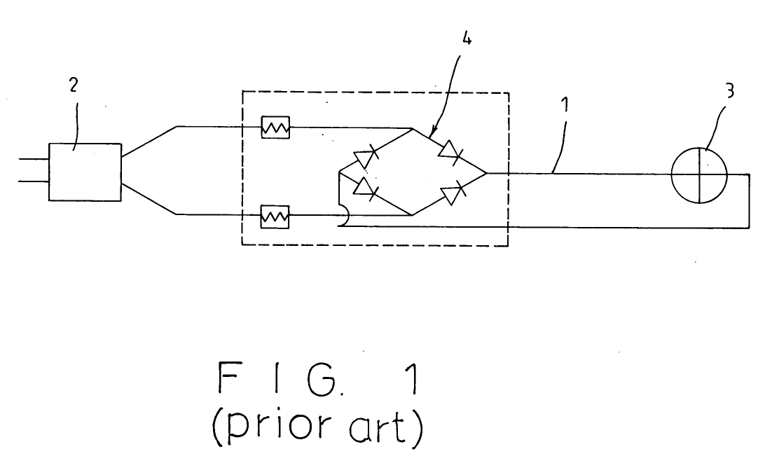

### DETAILED DESCRIPTION OF THE PREFERRED EMBODIMENT

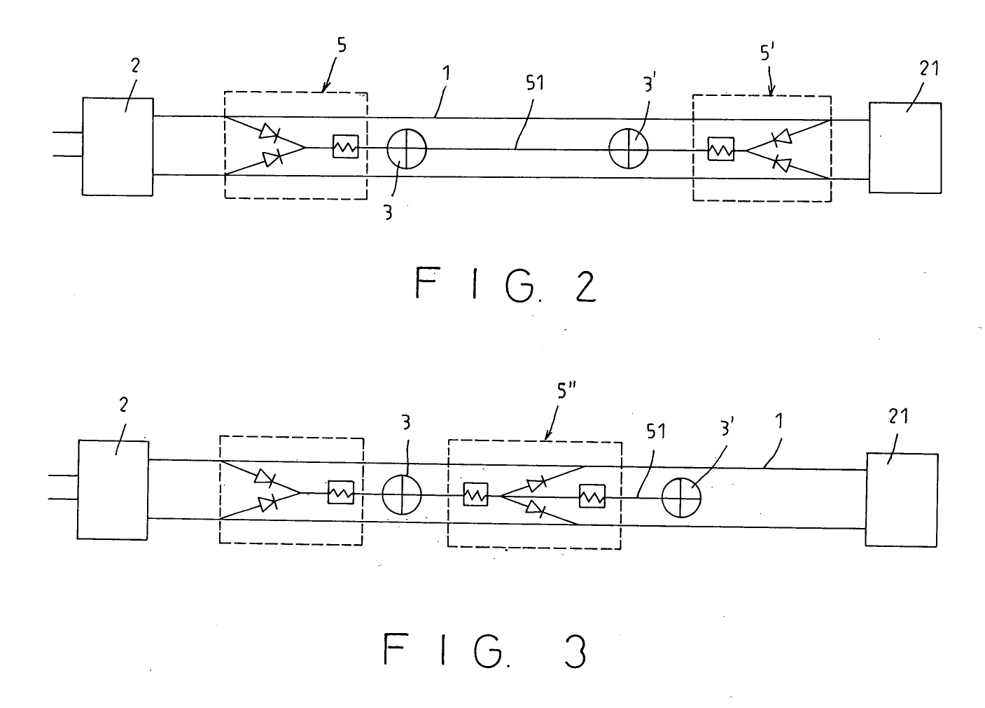

Please refer firstly to FIG. 2. The present invention includes a main circuitry (1), which connect-fitting a plug (2) in one end and setting tail socket (21) in the other end, in which main characteristic is to assemble two groups or more than two groups of dual crystal current controllers (5), (5′) in it, and a sub circuitry (51) set in between to connect fit with two LED lamp strings (3) (3′). By utilizing the diode (52) on the controller (5), (5′) to achieve bridge rectifying in sub circuitry (51), the sub circuitry (51) then stay at continuous DC current supply status thus no blinking in two LED lamp strings can be maintained.

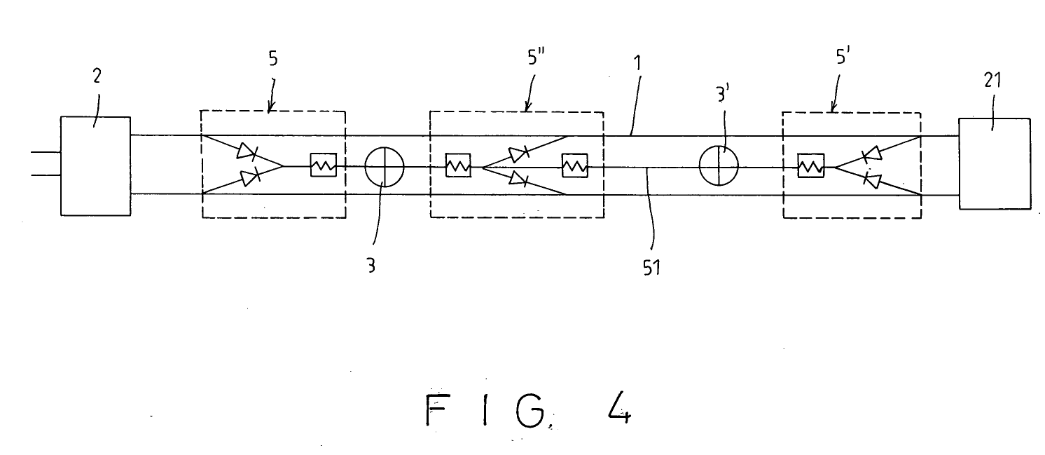

As shown mainly in FIG. 3, a reverse crystal current controller (5″) is set in between two LED lamp strings (3), (3′) on the sub circuitry (51) to replace the controller (5′) in the tail end to have the LED lamp string (3′) maintaining no blinking. And the other lamp (3′) will be formed as AC current supplying status, thus has the blinking effect. That is, the effect of blinking in portion of the lamp strings and no blinking in other portion of the lamp string can be achieved under such changes.

As shown in FIG. 4, two LED lamp strings will form as complete no blinking status while combining the controller (5′) in the tail end of the sub circuitry (51).

Whereas, the major characteristic of the present invention is to utilize the combination of forward and reverse current controllers with the main circuitry, and the formation of the sub circuitry for connection more than one LED lamp strings to be plug-fit directly in the family usage AC socket for obtaining the effects of complete no blinking and partial blinking. Thus, the invention has better advancement and innovation known products compared to known product and should have conformed to the requirement for patent approval. Accordingly, the present invention obtains improvement and effects and should be allowed for a patent. And it is to be understood that the aforesaid embodiments are just exemplary and are not to limit the scope of the present invention.

I claim:

1. A LED lamp sting comprising a main circuitry which combining a plug in one end and combining tail socket in the other end, and the plug can insert fit directly into the AC current socket, and the characteristic is in that combining more than one forward or reverse dual crystal current controllers with the main circuitry to achieve the object of bridge-rectifying, and a sub circuitry set in between to connect more than one LED lamp strings.

2. A LED lamp sting as claimed in claim 1, wherein said main circuitry is connect-fit with two forward dual current controllers and formed the DC current in the sub circuitry located in between.

3. A LED lamp sting as claimed in claim 1, wherein said main circuitry is connect-fit with one forward dual crystal current controller and one reverse dual crystal current controller to form DC current in sub circuitry located in between and AC current in the external extension end of the reverse dual crystal current controller.
